(19) United States
(12) Patent Application Publication
(10) Pub. No.: US 2014/0266609 A1
(43) Pub. Date: Sep. 18, 2014

(54) System and Method for Locating Wireless Nodes

(71) Applicant: MICROCHIP TECHNOLOGY INCORPORATED, Chandler, AZ (US)

(72) Inventor: Yifeng Yang, Chandler, AZ (US)

(73) Assignee: MICROCHIP TECHNOLOGY INCORPORATED, Chandler, AZ (US)

(21) Appl. No.: 13/831,596

(22) Filed: Mar. 15, 2013

(51) Int. Cl. G06K 7/10

(52) U.S. Cl. CPC G06K 7/10366
USPC 340/8.1

(57) ABSTRACT

A tracking system includes a network; a plurality of signal sources communicatively coupled to the network, the plurality of signal sources configured to transmit substantially identical signals; and an RFID tag configured to receive the substantially identical signals from the plurality of signal sources, determine points of intersection from hyperbola curves defining phase differences between the substantially identical signals, a point of intersection of three hyperbola curves defining a location of the user device. In some embodiments, the plurality of signal sources comprise a single transmitter and a predetermined plurality of substantially identical antennas coupled to the single transmitter by cables of a substantially same length.

### BACKGROUND OF THE INVENTION

1. Technical Field

The present disclosure relates to radiofrequency identification (RFID) systems and, particularly, to a relatively low-cost system and method for locating a wireless node in an RFID system.

2. Description of the Related Art

Asset tracking generally refers to the use of one or more wireless links to convey information from a radiofrequency identification (RFID) microchip or “smart tag” attached to a physical asset, such as a person or animal or other object of interest. Asset tracking may be used, for example, in warehouse and store operations for inventory and product tracking. Typically, an infrastructure tracking system detects one or more signals from the RFID smart tag and ascertains its location. In product tracking applications, due to the necessity of a large number of tags, it is important that implementation be relatively simple and relatively inexpensive.

Most short-range, low-cost asset tracking relies on RSSI (received signal strength indication) methods. Broadly speaking, RSSI provides an indication of the power level received at an antenna. Thus, asset tracking using RSSI determines the asset's location based on the strength of the signal received from the asset's smart tag at a particular system antenna or station. However, RSSI can be adversely affected by multipath interference. That is, the signal from the smart tag may reach the antenna by more than one path, thus leading to an erroneous determination of the asset's location. As a consequence, accuracy using RSSI can be relatively poor.

Other location determination and/or tracking solutions are known. Some navigation and asset tracking system, for example, may make use of global positioning system (GPS) technology. GPS technology requires a GPS receiver and an unobstructed line of sight to four or more GPS satellites. In general, GPS relies on a time of travel determination and requires knowledge of the time a GPS message is transmitted and the satellite position at the time of transmission. Thus, the GPS receiver generally must be outdoors, and relatively precise timing and clock synchronization is required at both the satellite and the GPS receiver. Further, GPS tracking system implementations are relatively complex, relatively expensive and may be cost prohibitive for low-cost solutions. For example, GPS receivers are typically installed in cellular telephones or in stand-along navigation computers, which are unsuitable for tracking of large numbers of objects, such as a store or warehouse inventory, for example.

The LORAN (Long Range Aid to Navigation) system allows ships and aircraft to determine their positions from radio signals transmitted by fixed land-based radio beacons, using an on-board receiver. In general, LORAN employs a master station to send out a signal and slave stations which relay message with different delays. LORAN determines a position of a ship or aircraft based on the time difference between signals from different stations. However, LORAN is relatively complex and the relay stations can introduce timing errors. Further, accuracy is only about 0.1-0.25 nautical miles, making a LORAN based system unsuitable for asset tracking.

### SUMMARY

These and other drawbacks in the prior art are overcome in large part by a system and method according to embodiments of the present invention.

A tracking system in accordance with embodiments includes a network; a plurality of signal sources communicatively coupled to the network, the plurality of signal sources configured to transmit substantially identical signals; and an RFID tag configured to receive the substantially identical signals from the plurality of signal sources, determine points of intersection from hyperbola curves defining phase differences between the substantially identical signals, a point of intersection of three hyperbola curves defining a location of the user device. In some embodiments, the plurality of signal sources comprise a single transmitter and a predetermined plurality of substantially identical antennas coupled to the single transmitter by cables of a substantially same length.

A method for tracking a device in accordance with embodiments includes transmitting a plurality of substantially identical signals from a plurality of signal sources; receiving the substantially identical signals at an RFID tag from the plurality of signal sources; and determining points of intersection from hyperbola curves defining phase differences between the substantially identical signals, a point of intersection of three hyperbola curves defining a location of the RFID tag. In some embodiments, the plurality of signal sources comprise a single transmitter and a predetermined plurality of substantially identical antennas coupled to the single transmitter by cables of a substantially same length.

A tracking device in accordance with some embodiments includes a transceiver for receiving a plurality of substantially identical signals from a plurality of signal sources; and a location processing module operably coupled to the transceiver and configured to identify a phase difference in the substantially identical signals, the location processing module further configured to identify a point of intersection of curves defining the phase differences between pairs of the plurality of substantially identical signals.

A computer program product according to embodiments includes tangible machine readable instructions for tracking a device, the instructions for transmitting a plurality of substantially identical signals from a plurality of signal sources; receiving the substantially identical signals at an RFID tag from the plurality of signal sources; and determining points of intersection from hyperbola curves defining phase differences between the substantially identical signals, a point of intersection of three hyperbola curves defining a location of the RFID tag.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram illustrating an exemplary asset tracking system according to embodiments.

FIG. 2 illustrates an exemplary architecture for an asset tracking system according to embodiments.

FIGS. 3A-3C illustrate asset tracking according to embodiments.

FIG. 4 illustrates an exemplary station configuration according to embodiments;

FIG. 5 is a flowchart illustrating operation of embodiments.

### DETAILED DESCRIPTION

The disclosure and various features and advantageous details thereof are explained more fully with reference to the exemplary, and therefore non-limiting, embodiments illustrated in the accompanying drawings and detailed in the following description. Descriptions of known programming techniques, computer software, hardware, operating platforms and protocols may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

As will be explained in greater detail below, a system and method for locating wireless nodes in an asset tracking system measures the difference of distance from three radio sources transmitting identical signals. Locations with the same distance differences from any two of the radio sources define hyperbolas. The intersection of the hyperbolas identifies the location of the wireless node. Advantageously, embodiments described herein provide a low-cost accurate signal source for multiple antennas; and accurate timing difference retrieval based on symbol differences, which is relatively easy to detect with multi-symbol modulation and a high frequency carrier signal. Thus, embodiments provide low-cost RFID implementation in a relatively small environment, such as an office, warehouse, or store.

Turning now to the drawings and with particular attention to FIG. 1, a diagram illustrating an asset tracking system 100 according to embodiments is shown. As shown in FIG. 1, the system 100 includes one or more RFID tags 102. The RFID tags 102 may include radiofrequency receivers and/or transmitters. As will be explained in greater detail below, the RFID tags 102 may be configured to receive radiofrequency signals from one or more transmitters coupled to antennas 104a, 104b, 104c. Based on the timing of the signals, the RFID tags 102 may determine their locations. Typically, the system 100 including antennas 104a, 104b, 104c is implemented in a relatively small geographical area, such as a factory or warehouse or business or other campus.

The RFID tags 102 and/or controllers (not shown) associated with the antennas 104a-104c may further be in communication over one or more networks 106 with one or more computers 108. The one or more networks 106 may be implemented as any wired or wireless network, such as the Internet or local or wide area networks or public or private Intranets. The computer 108 may be any suitable computing device, such as a laptop, tablet, or desktop computer, a server, or cellular telephone or smart phone. In some embodiments, the RFID tags 102 may transmit their locations and/or other information to the computer 108. The computer 108, in turn, may communicate the RFID tag's location to a user.

A hardware architecture for using embodiments is described more particularly in FIG. 2. In particular, FIG. 2 illustrates an exemplary architecture and includes a RFID tag 102 that may be bi-directionally coupled to network 106, and a monitoring device, such as a computer 108 that may be bi-directionally coupled to the network 108. The computer 108 may include a central processing unit (“CPU”) 206, a read-only memory (“ROM”) 208, a random access memory (“RAM”) 210, a hard drive (“HD”) or storage memory 212, input/output device(s) (“I/O”) 214, and network interface(s) (NIC). The I/O 214 can include a keyboard, monitor, printer, electronic pointing device (e.g., mouse, trackball, etc.), or the like.

The RFID tag 102 may include a microcontroller 201, ROM 202, RAM 203, NIC 204, and transceiver 205. Each of the computer 108 and the RFID tags 102 may be an example of a data processing system. ROM 202 and 208, RAM 203 and 210, and HD 212, include media that can be read by the MCU 201 or the CPU 206. Therefore, each of these types of memories includes a data processing system readable storage medium. These memories may be internal or external to the computer or mobile device.

The methods described herein may be implemented in suitable software code that may reside within ROM 202 and 208, RAM 203 and 210, and HD 212. In addition to those types of memories, the instructions in an embodiment of the present invention may be contained on a data storage device with a different data processing system readable storage medium, such as a USB drive. Alternatively, the instructions may be stored as software code elements on a DASD array, magnetic tape, floppy diskette, optical storage device, or other appropriate data processing system readable storage medium or storage device.

Communications between the RFID tag 102 and the computer 108 can be accomplished using electronic, optical, radio-frequency, or other signals. When a user (human) is at the computer 108, the computer 108 may convert the signals to a human understandable form when sending a communication to the user and may convert input from a human to appropriate electronic, optical, radio-frequency, or other signals to be used by the computer 108 or the RFID tag 102. Typically, the RFID tag 102 is implemented as a relatively simple, small, inexpensive, standalone device with a microcontroller.

As will be explained in greater detail below, in some embodiments, the transceiver 205 of the RFID tag 102 receives signals from the antennas 104a-104c. From these, a location processing module 207 of either the transceiver 205 or the MCU 201 derives the location of the mobile station 102. The RFID tag 102 may then transmit the tag's location using the network interface 204 to the computer 108.

Operation of embodiments is shown schematically with reference to FIGS. 3A-3C. Shown in FIG. 3A are antennas 104a and 104b, and a wireless node or device 102. Antenna 102a transmits a signal 302 to the mobile device 102, while antenna 104b transmits a signal 304. In some embodiments, the signals are multi-symbol signals. In some embodiments, the signals are, for example, 16 symbol O-QPSK signals.

The signal 302 from antenna 104a travels a distance (tr−ttA)*C, while the signal 304 from antenna 102b travels a distance (tr−ttB)*C, where C is the speed of light, tr is the time of the transmissions are received, and ttA and ttB are the times the signals are sent from the respective antennas. The symbols will be received at the mobile device with a phase difference of ttA−ttB.

As shown in FIG. 3B, the phase difference ttA−ttB or time difference between symbols defines a distance (ttA−ttB)*C, which describes a hyperbola 306. That is, the hyperbola 306 defines the locus of points for which the distance between the two antennas is (ttA−ttB)*C.

Although in some applications, this would be sufficient to provide a location of the RFID tag, in others, three antennas may be provided, and the intersection of the resulting three hyperbolas can identify a unique position. This is illustrated more particularly in FIG. 3C. Shown are antennas 104a, 104b, and 104c, and an RFID tag 102. The time difference between the signals from Antenna 104a and Antenna 104c defines a hyperbola 310; the time difference between signals from Antenna A and Antenna 104B defines hyperbola 306, and the time difference between signals from Antenna 104B and Antenna 104C defines a hyperbola 308. The three hyperbolas intersect at a location 312.

As can be appreciated, while some embodiments employ separate antennas, each with its own transmitter, in some instances it may be difficult to achieve identical signals when different transmitters are in use. In some environments, therefore, it may be advantageous to provide a single transmitter and multiple identical antennas. Such a configuration is shown in FIG. 4. Rather than three independent signal sources comprising three independent transmitters, the signal sources comprise a single transmitter or transceiver 205 with identical antennas 402a, 402b, 402c coupled to transmit signals from the transceiver. In some embodiments, the antennas 402a-402c are coupled via identical lengths of cable, l. This ensures that the signal phase is identical for all signal sources. In this case, the timing of the signal on/off is used to identify the source antenna.

Turning now to FIG. 5, a flowchart 500 illustrating operation of embodiments is shown. Once the system 100 (FIG. 1) is activated, an RFID tag 102 may receive location signals from the antennas 104A-104B (step 502). The RFID tag 102 identifies the time difference between the signals (step 504). In some embodiments, this may be performed by the receiver rather than the on-board MCU 201 (FIG. 2). As noted above, the time differences between the signals define hyperbolas. The mobile device then identifies the location of the intersection of the hyperbolas (step 506). Finally, the location of the RFID tag 102 may be displayed or otherwise provided to a user. For example, the location may be transmitted to the computer 108 (FIG. 1).

Although the foregoing specification describes specific embodiments, numerous changes in the details of the embodiments disclosed herein and additional embodiments will be apparent to, and may be made by, persons of ordinary skill in the art having reference to this description. In this context, the specification and figures are to be regarded in an illustrative rather than a restrictive sense, and all such modifications are intended to be included within the scope of this disclosure. Accordingly, the scope of the present disclosure should be determined by the following claims and their legal equivalents.

What is claimed is:

1. A tracking system, comprising:
a network;
a plurality of signal sources communicatively coupled to the network, the plurality of signal sources configured to transmit substantially identical signals; and
an RFID tag configured to receive the substantially identical signals from the plurality of signal sources, determine points of intersection from hyperbola curves defining phase differences between the substantially identical signals, a point of intersection of three hyperbola curves defining a location of the user device.

2. A tracking system in accordance with claim 1, wherein the plurality of signal sources comprise a plurality of transmitters and a corresponding plurality of antennas.

3. A tracking system in accordance with claim 1, wherein the plurality of signal sources comprise a single transmitter and a predetermined plurality of substantially identical antennas coupled to the single transmitter by cables of a substantially same length.

4. A tracking system in accordance with claim 1, wherein the substantially identical signals are O-QPSK signals.

5. A tracking system in accordance with claim 1, further including a monitoring device configured to receive an indication of the RFID tag's location from the RFID tag.

6. A method for tracking a device, comprising:
transmitting a plurality of substantially identical signals from a plurality of signal sources;
receiving the substantially identical signals at an RFID tag from the plurality of signal sources; and
determining points of intersection from hyperbola curves defining phase differences between the substantially identical signals, a point of intersection of three hyperbola curves defining a location of the RFID tag.

7. A method for tracking a device in accordance with claim 6, wherein the plurality of signal sources comprise a plurality of transmitters and a corresponding plurality of antennas.

8. A method for tracking a device in accordance with claim 6, wherein the plurality of signal sources comprise a single transmitter and a predetermined plurality of substantially identical antennas coupled to the single transmitter by cables of a substantially same length.

9. A method for tracking a device in accordance with claim 6, wherein the substantially identical signals are O-QPSK signals.

10. A method for tracking a device in accordance with claim 6, further including a monitoring device configured to receive an indication of the RFID tag's location from the RFID tag.

11. A tracking device, comprising:
a transceiver for receiving a plurality of substantially identical signals from a plurality of signal sources;
a location processing module operably coupled to the transceiver and configured to identify a phase difference in the substantially identical signals, the location processing module further configured to identify a point of intersection of curves defining the phase differences between pairs of the plurality of substantially identical signals.

12. A tracking device in accordance with claim 11, further comprising a network interface for communicating a location of the point of intersection to a monitoring device.

13. A tracking device in accordance with claim 11, wherein the substantially identical signals are O-QPSK signals.

14. A tracking device in accordance with claim 11, wherein the curves are hyperbola curves.

15. A computer program product including tangible machine readable instructions for tracking a device, the instructions for:
transmitting a plurality of substantially identical signals from a plurality of signal sources;
receiving the substantially identical signals at an RFID tag from the plurality of signal sources; and
determining points of intersection from hyperbola curves defining phase differences between the substantially identical signals, a point of intersection of three hyperbola curves defining a location of the RFID tag.

16. A computer program product in accordance with claim 15, wherein the plurality of signal sources comprise a plurality of transmitters and a corresponding plurality of antennas.

17. A computer program product in accordance with claim 15, wherein the plurality of signal sources comprise a single transmitter and a predetermined plurality of substantially identical antennas coupled to the single transmitter by cables of a substantially same length.

18. A computer program product in accordance with claim 15, wherein the substantially identical signals are O-QPSK signals.

19. A computer program product in accordance with claim 15, further including a monitoring device configured to receive an indication of the RFID tag's location from the RFID tag.

20. A computer program product including tangible machine readable instructions for tracking a device, the instructions for:
receiving a plurality of substantially identical signals from a plurality of signal sources at an RFID tag; and
determining points of intersection from hyperbola curves defining phase differences between the substantially identical signals, a point of intersection of three hyperbola curves defining a location of the RFID tag;
wherein the plurality of signal sources comprise a plurality of antennas coupled via same length cables to a single transmitter.
